(19) United States
(12) Patent Application Publication
(10) Pub. No.: US 2011/0298841 A1
(43) Pub. Date: Dec. 8, 2011

(54) OUTDOOR DISPLAY SYSTEM AND DISPLAY APPARATUS

(75) Inventor: Hideo FUJIMORI, Sakai City (JP)

(73) Assignee: SANYO Electric Co., Ltd., Osaka (JP)

(21) Appl. No.: 13/149,380

(22) Filed: May 31, 2011

(30) Foreign Application Priority Data
Jun. 7, 2010 (JP) 2010-129846
Jun. 29, 2010 (JP) 2010-147775

(51) Int. Cl. G09G 5/10; G06F 1/26

(52) U.S. Cl. 345/690; 713/300

(57) ABSTRACT

The outdoor display system has a solar cell; electricity storing device which stores electric power; a display apparatus which displays information, and a control device which supplies the electric power obtained by the solar cell to the display apparatus or the electricity storing unit. The control device has an acquisition part which acquires weather forecast information, and an accommodating adjusting part which accommodates adjusts the ratio of the electric power supplying to the display apparatus or to the electric power storing to the electricity storing unit according to the weather forecast information acquired by the acquisition part.

### CROSS-REFERENCE TO RELATED APPLICATIONS

This application is based on Japanese Patent Application No. 2010-129846 (filed on Jun. 7, 2010) and Japanese Patent Application No. 2010-147775 (filed on Jun. 29, 2010), the contents of which are hereby incorporated by reference.

### BACKGROUND OF THE INVENTION

1. Field of the Invention

The present invention relates to an outdoor display system or a display apparatus. Specifically, the system equips a power generator such as a solar cell, and is suitable when employed as bus stop etc.

2. Description of the Related Art

In recent years, an advertising media called digital signage is emerging. In the digital signage, images or information are displayed on a flat-panel display using a digital technology. Such digital signage apparatus is utilized in facilities such as bus stops.

However, when installing digital signage displays outdoors, since it is necessary to supply electric power from a power line, electric construction is further needed besides installation works. This is one of the obstacles when marketing (or selling) the digital signage apparatuses.

This obstacle may be eliminated by unifying a solar cell and a secondary battery with the digital signage apparatus. Thereby, it is not necessary to supply electric power from a power line. However, when rainy weather, since the solar cell cannot generate power, it is necessary to supply electric power to the signage apparatus from the secondary battery. If the rainy weather continues, the electric power stored in the battery may run down.

### SUMMARY OF THE INVENTION

The outdoor display system according to the present invention has a solar cell; an electricity storing device which stores electric power; a display apparatus which displays information, and a control device which supplies the electric power obtained by the solar cell to the display apparatus or the electricity storing unit, wherein the control device comprises: an acquisition part which acquires a weather forecast information, and an accommodating part which accommodates the ratio of the electric power supplying to the display apparatus to the electricity storing unit according to the weather forecast information acquired by the acquisition part.

### DESCRIPTION OF THE DRAWINGS

FIG. 1 is an outline view of the outdoor display system 10.

FIG. 2 is a block diagram showing a composition of the outdoor display system 10.

FIG. 3 is a block diagram showing a composition of the controller 7.

FIG. 4 is a flow chart showing an example of the process executed by the controller 7.

FIG. 5 is a block diagram showing a composition of the outdoor display system 20.

### DESCRIPTION OF THE PREFERRED EMBODIMENTS

### First Embodiment

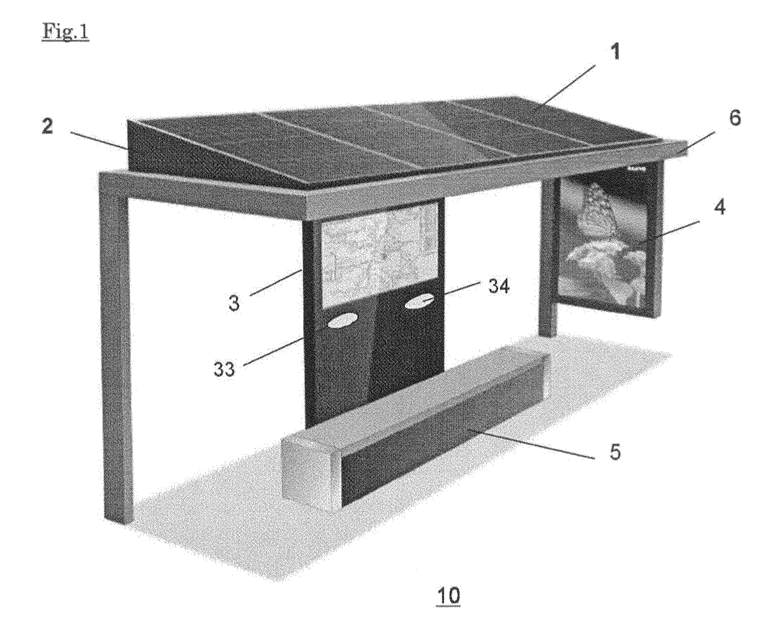

FIG. 1 is an outline view of the outdoor display system 10 which is an embodiment of the present invention.

The outdoor display system 10 has a solar cell 1, a secondary battery 2, a display apparatus 3, a poster 4, a bench (seat) 5, and a roof 6.

The solar cell 1 generates electricity by photo-electric converting the sunlight. Here, the cell 1 includes a solar cell module consisted by solar array panels etc., and the inverter. The secondary battery 2 is a lithium-ion battery (battery pack), for example.

The display apparatus 3 is a LCD display equipped with a display panel 32 such as a Liquid Crystal Panel (LCD). The apparatus 3 displays contents (images) transmitted from an external contents server or a broadcasting station, or contents stored in a supplemental (add-on) storage devices. When installed in a bus stop, the apparatus 3 displays a route map of the bus, a operating, situation (for example, the arrival information of a bus at a neighboring bus stop) etc.

Further, in the present embodiment, the apparatus 3 has an antenna (contained in the transceiver unit 35 mentioned below) for receiving contents transmitted by wireless or by broadcast.

As described above, the apparatus 3 is driven by electricity generated by the solar cell 1, and does not require to supply electric power from a power line. In other words, the display apparatus 3 operates in “off-grid”. Thus, the electric construction for drawing electric power from the power line is not necessary. Further, by equipping an antenna, it is unnecessary to install the cable for connecting to a LAN or WAN networks to receive contents data. Thereby, this outdoor display system 10 mitigates the burden of installation, and should contribute for marketing (selling or wide use of) the digital signage systems.

In the lower part surface of an image displaying portion of the display apparatus 3, the human sensor 33 and the camera sensor 34 are arranged.

The human sensor 33 is for detecting an existence of a person in the bus stop, and for example, an infrared sensor is used. When the sensor 33 determines that a person does not exist, the display apparatus 3 reduces the illumination of the backlight 39, or turns the backlight 39 off. Thereby, the electric power is reduced.

The camera sensor 34 determines an attributes of a person in the bus stop based on photographed images. When determined that a person is female, for example, an advertisement of cosmetics may be displayed. When it is determined male, an advertisement of beer may be displayed.

A poster 4 comprises an advertising film which transmits a light and advertisement is printed thereon, and a fluorescent light which irradiates the film from the inner side (side opposite from the displaying side). The poster 4 is similar to the display apparatus 3 in sense that it displays an advertisement. However, the image displayed in the apparatus 3 changes every moment according to the received contents (i.e. if the contents is a moving image, the displaying image changes every seconds), while the image displayed in the poster 4 does not change basically since the poster displays a printed advertisement.

A bench 5 is arranged for a person in the bus stop, so that a person can sit down while waiting for the bus, and is arranged in the front side of the display apparatus 3. When the display apparatus 3 installed on the sidewalk so that its backside faces the street (driveway), a person sitting on the bench 5 will be waiting for the bus while watching the advertising contents displayed on the apparatus 3. When the display apparatus 3 is installed facing its displaying side to the street (driveway), a passenger in the bus, a person in a car driving down the street, or a person on the sidewalk on the opposite side of the street can watch the advertising contents displayed on the apparatus 3. Needless to say, a person sitting on the bench 5 can watch advertising contents if he turns his back to the street too.

The roof 6 is arranged above the display apparatus 3 and functions as a shade or a rain-cover for the apparatus 3. Also it covers a person waiting for the bus. On the roof 6, the solar cell 1 or the secondary battery 2 is arranged, thus the roof 6 functions as installation stands also. Considering the direction of the sunlight, the surface of the cell 1 is inclined against the roof 6. The battery 2 may be arranged between the cell 1 and the roof 6, utilizing a triangular prism-like space occurred by the inclined roof 6.

Although it is not illustrated in FIG. 1, the outdoor display system 10 also has a controller 7. The controller 7 supplies the electric power generated by the solar cell 1 to the display apparatus 3 and the secondary battery 2.

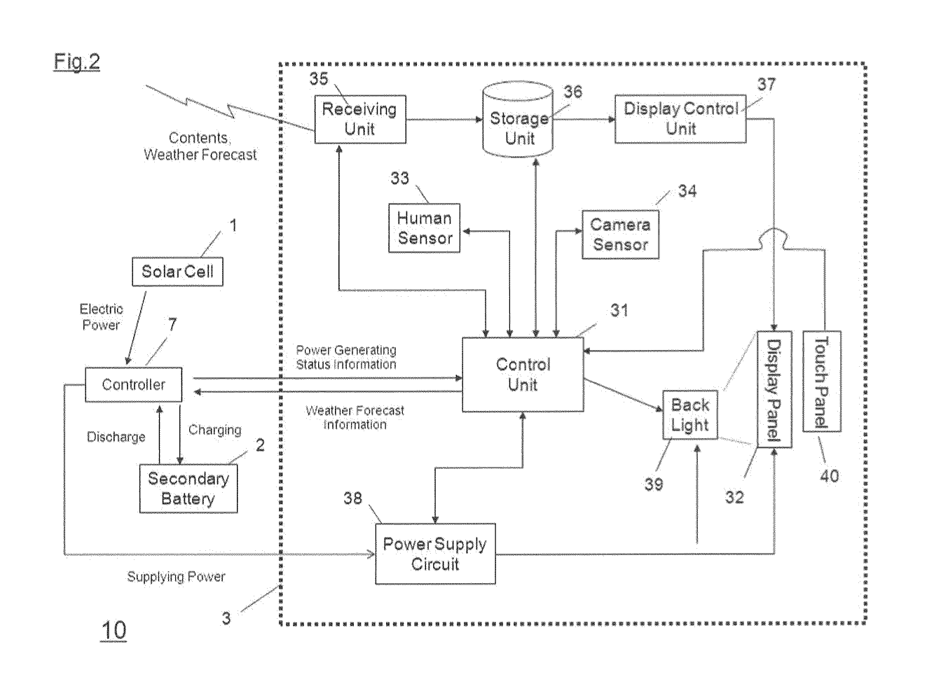

FIG. 2 is a block diagram showing the composition of the outdoor display system 10. As mentioned referring to the FIG. 1, the system 10 has a solar cell 1, a secondary battery 2, and a display apparatus 3. The apparatus 3 has a control unit 31, a display panel 32, a human sensor 33, a camera sensor 34, a transceiver unit 35, a storage unit 36, a display control unit 37, a power supply circuit 38, a backlight 39, and a touch panel 40.

The electric power generated by the solar cell 1 is sent to the controller 7. Basically, the controller 7 supplies most of the power generated by the cell 1 to the display apparatus 3. The surplus electric power (which is a difference between the power generated by the solar cell 1 and the power consumed in the display apparatus 3) is supplied to the storage battery 2: In nighttime or rainy weather days, a controller 7 is controlled so that the electric power is supplied to the display apparatus 3 from the secondary battery 2.

As mentioned above, basically, the display apparatus 3 of the present embodiment does not receive, electric power supply from a power line, and operates as “off-grid” and the electric power for driving the display apparatus 3 is provided by the solar cell 1. Thus, the performance (or specification) of the solar cell 1 should be selected (or designed) considering the power consumed in the display apparatus 3. In detail, first, the electric-generating capacity required for the solar cell should be determined, based on the amount of power consumption in the apparatus 3. Then, size (surface area) of the cell should be determined considering the power generating efficiency of the solar cell 1. The capacity of the secondary battery 2 should be determined considering the case when sunlight does not glare, such as rainy weather or night time.

The control unit 31 collects the state information of each portion (i.e. the display panel 32, the touch panel 40 etc.) of the display apparatus 3. The unit 31 controls each of the portions based on the collected information. The power generating status information from the solar cell 1 or the residual capacity information from the secondary battery 2 are also inputted to the control unit 31. The unit 31 is constituted by CPU.

The display panel 32 is a portion which actually displays an image, and an LCD panel is employed for display apparatus 3. In the panel, liquid crystal corresponding to each pixel of the panel is driven between ON/OFF state (or to intermediate state).

The human sensor 33 is for detecting the person's existence in the bus stop as described above. The camera sensor 34 is for determining the characteristic of the person in the bus stop. The sensors 33 and 34 are connected with the control unit 31, and the detected results in these sensors are inputted to the unit 31.

The transceiver unit 35 has an antenna which receives a signal, from contents server (for example, ASP server, or personal computer) transmitted by wireless networks (for example, WiMAX or IEEE802.11b/g), and a signal-processing unit which demodulates the signal received by the antenna. The receiving signal are, for example, advertising contents, control signals for the display system 10 transmitted from the administrator (or management company) of the system 10, or a local weather forecast information transmitted from a weather forecast company. When the advertisement contents is in a MPEG 2-TS format signal modulated by OFDM system, the unit 35 demodulates the OFDM signal and then extracts the MPEG 2-TS signal. The extracted MPEG 2-TS signal is outputted to the storage unit 36. The unit 35 may also have a function for receiving a broadcast wave from a television broadcasting station, like an ordinary television does.

Further, the transceiver unit 35 can transmit a signal outside by wireless communication using a transmitting antenna. The transmitting signal is for example, operation information (or failure information) of the display system 10. This information is transmitted to the administrator of the outdoor display system 10. If the content displayed by the display panel 32 is an interactive content, the input made by a user of the touch panel 40 is transmitted to a contents server via the transceiver unit 35.

Further, out of the signals received by the transceiver unit 35, the control signal of the outdoor display system 10 or the local weather forecast information are transmitted to the controller 7 via the control unit 31 and the control unit 73. The controller 7 controls the outdoor display system 10 using these signals or information.

The storage unit 36 stores a MPEG 2-TS signal extracted by the transceiver unit 35. In other words, the unit 36 stores the contents transmitted from contents server or broadcasting station. If the content is real-time type content (which is displayed by the display panel 32 immediately after the reception in the transceiver unit 35), the storage unit 36 functions as a buffer memory. If the content is storage-type contents (which is displayed according to the operation of a user or displayed based on a time schedule), the storage unit 36 functions as storage media.

The display control unit 37 performs a display control in the display panel 32. Specifically, according to the image signal of the contents, the unit 37 controls the corresponding pixels of the display panel 32 (LCD panel). Since the unit 37 needs to perform a high-speed processing, hardware circuit provided independently from the control unit 31 (constituted by CPU) is utilized.

The power supply circuit 38 supplies power to each portion of the display apparatus 3. Based on an assumption that the power consumption in the display panel 32 and the backlight 39 is larger than the other portions, it is described in FIG. 2 such that the power is supplied only to the panel 32 and the backlight 39. However, the power supply circuit 38 actually supplies electric power to the transceiver unit 35, the storing unit 36, the display control unit 37, the human sensor 33, the camera sensor 34, and the touch panel 40 as well.

The backlight 39 irradiates a light to the display panel 32. As the backlight, fluorescent light or an LED light source is used for example. Since the display apparatus 3 of the present embodiment is used in “off-grid” mode, it is desired that the power consumption is low. From this viewpoint, LED light source may be desirable.

The touch panel 40 is transparent and is an electric capacity-type touch sensor. This touch panel 40 is arranged at the front side of the display panel 32. The touch panel 40 accepts an input from a user. For example, when the display panel 32 displays the image of buttons for accepting the user to make selection out of three choices, it regards the input is made by a user when the user touches a position corresponding to the button image.

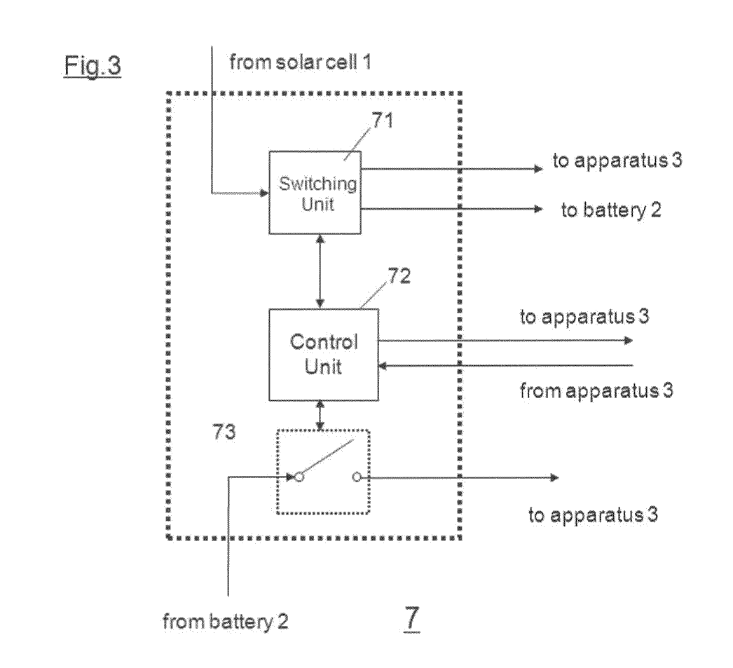

FIG. 3 is a block diagram showing the composition of a controller 7. The controller 7 has a switching unit 71, a control unit 72, and a switch 73. The unit 71 is for switching the determination of the power generated by the solar cell 1 among the display apparatus 3 or the secondary battery 2. The switching unit 71 is controlled by the control unit 72. This switching unit 71 may be constituted by switch which selects a single input among two inputs. Alternatively, this unit 71 may be able to change the ratio of the electric power outputted to the display apparatus 3 to the electric power outputted to the secondary battery 2 (for example, 50% of the power may be provided to apparatus 3 and the other 50% to battery 2, or 100% may be provide to either apparatus 3 or battery 2, or 75% to the apparatus 3 and 25% to battery etc.).

The control unit 72 performs various controls inside the controller. Further, the unit 72 receives control information (for example, weather forecast information) from the display apparatus 3 or transmits a control signal to the apparatus 3.

The switch 73 is for switching whether the electric power stored in the secondary battery 2 should be outputted to the display apparatus 3 or not. The switch 73 is controlled by the control unit 72. The controller 7 may also have an antenna for receiving a wireless signal, and the weather forecast information may be received directly instead of via the display apparatus 3.

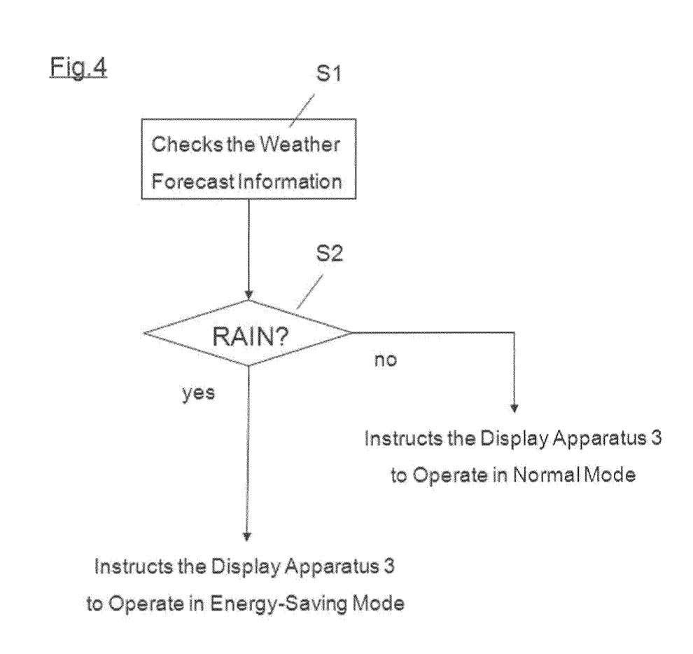

FIG. 4 is a flow chart showing an example of a process performed by the controller 7.

In step S1, the control unit 72 checks the content of weather forecast information.

In the step S2, when the forecast is rainy, the unit 72 transmits a signal to the display apparatus 3 instructing the apparatus 3 to operate in energy-saving mode. Further, the unit 72 controls the switching unit 71 so that the ratio outputted to the secondary battery 2 out of the output power from the solar cell 1 becomes high.

On the other hand, when the forecast mentions that the weather will be fine, the unit 72 transmits the signal to the display apparatus 3 instructing the apparatus 3 to operate in a normal mode (non energy-serving mode). Further, the unit 72 controls the switching unit 71 so that the ratio outputted to the secondary battery 2 out of the output power from the solar cell 1 become low, or the unit 72 may control so that all the power outputted from the cell 1 is outputted to the apparatus 3.

When instructed to operation in energy-saving mode, the display apparatus 3 controls the backlight 39 so that the luminosity become lower than the standard setting.

Thereby, the controller 7 controls the display apparatus so that the apparatus operates in a power-saving mode predicting a possibility of becoming rainy weather.

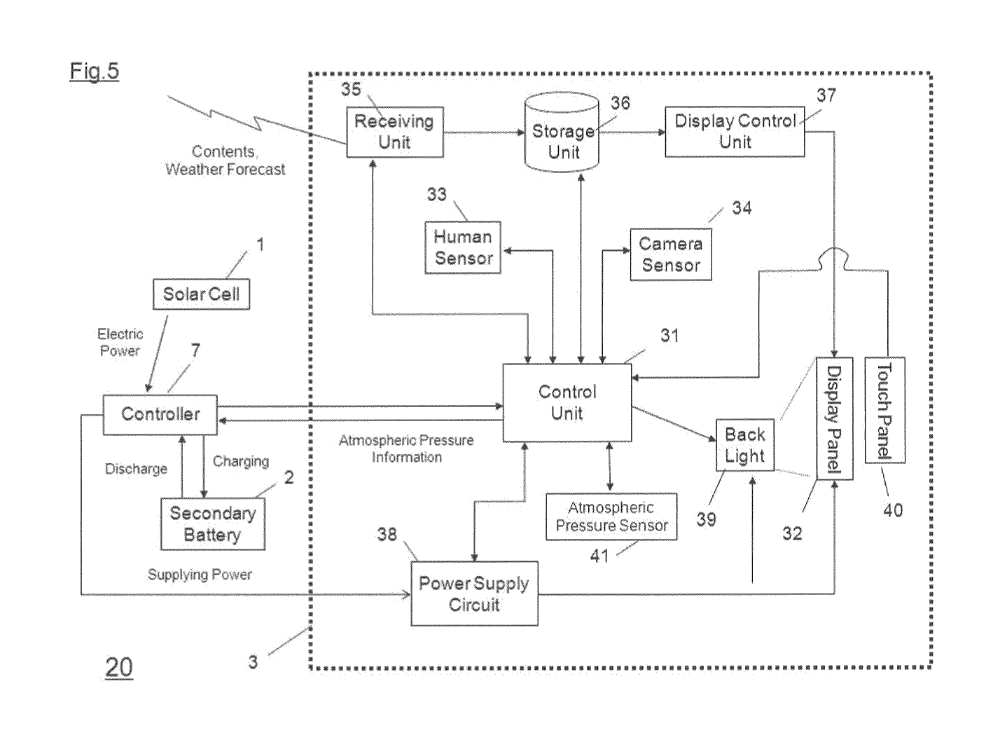

FIG. 5 is a block diagram showing the composition of the outdoor display system 20 of the present embodiment. Here, the same number is assigned for the portion common with the system 10 of the first embodiment. Hereafter, the feature peculiar to the present embodiment is explained.

In the back side of a display apparatus 3, an atmospheric pressure sensor 41 is arranged. This sensor 41 is for detecting an open air pressure. Before a rainy weather, the atmospheric pressure tends to fall. In such weather, since the sunlight is intercepted by clouds, the solar cell 1 cannot generate electric power. Thereby, electricity stored in the secondary battery 2 keeps on decreasing and it may disappear completely at the end. Therefore, according, to the present embodiment, assuming that the rain may likely to fall when it is detected in the sensor 41 that the atmospheric pressure is decreasing, the luminosity of the backlight set lower than a standard setting.

The atmospheric pressure information detected by the sensor 41 is transmitted to the controller 7 via the control unit 31. Based on this atmospheric pressure information, the controller 7 changes the ratio of the power supplying to the display apparatus 3 to the power supplying to the secondary battery 2. Specifically, when the current atmospheric pressure is low, the controller increases the ratio supplying to the battery 2. This is because when the atmospheric pressure is low, it is likely to rain, and thus it is required to secure the power supply from the battery 2 to the display apparatus 3 to prepare for the rainy weather.

The embodiment of the present invention is described as above. However, the scope of the present invention is not limited thereto, and the present invention may be implemented by being subjected to various modifications without departing from the gist of the present invention.

For example, an atmospheric pressure information measured by the atmospheric pressure sensor 41 may be transmitted periodically (or continuously) to the controller 7, or may be transmitted only when the pressure becomes lower than a predetermined value. The display apparatus 3 may control the luminosity of the backlight 39 based on the atmospheric pressure information, while adjusting the ratio of power supplying to the display apparatus 3 and to the secondary battery 2.

In the above, two sensors, i.e. the human sensor 33 and the camera sensor 34 are employed. Instead, the camera sensor 34 may also function as a human sensor. In such case, existence of a person is detected from a captured image instead of using infrared rays done by human sensor 33.

In the above, an LCD panel is explained as an example of the display portion of the display apparatus 3. Instead, plasma panel, organic EL (Electro-Luminescence), electronic paper, CRT, or an advertising film may be employed as the display portion.

In the above, the atmospheric pressure sensor 41 is arranged at the backside of a display apparatus 3. Instead it may be arranged inside the housing case of the apparatus 3. The sensor 41 may be formed separately from the display apparatus 3.

In the above, the controller 7 determines the ratio of the electric power supplying to the display apparatus 3 to the electric power storing to the secondary battery 2 according to the atmospheric pressure detected by the atmospheric pressure sensor 41. Instead, the controller 7 may determine the ratio based on the atmospheric pressure information transmitted by wireless network or internet.

In the above, the transceiver unit 35 of the display apparatus 3 receives the control signal from the administrator of the outdoor display system 10 or the weather forecast information from weather forecast company, and then the signal or the information is transmitted to the controller 7. Instead the controller 7 may employ the receiving unit. In such case, the above-mentioned control signal and the weather information may be received by the controller 7, and the advertising contents may be received by the display apparatus 3.

What is claimed is:

1. An outdoor display system comprising:
a solar cell;
an electricity storing device which stores electric power;
a display apparatus which displays information, and
a control device which supplies the electric power obtained by the solar cell to the display apparatus or the electricity storing unit, wherein the control device comprises:
an acquisition part which acquires a weather forecast information, and
an adjusting part which adjusts the ratio of the electric power supplying to the display apparatus to the electric power storing to the storing unit according to the weather forecast information acquired by the acquisition part.

2. A display apparatus, wherein the apparatus is supplied an electric power from a solar cell, the apparatus comprises:
a display panel which displays information;
a receiving unit which receives information transmitted by wireless;
a backlight which irradiates light to the display panel;
an acquisition unit which acquires a weather forecast information, and
a control unit which controls the luminosity of the backlight based on the information acquired by the acquisition unit, wherein
the control unit lowers the luminosity of the backlight when the weather forecast information acquired is rainy weather.
